(19) United States
(12) Patent Application Publication
(10) Pub. No.: US 2008/0284775 A1
(43) Pub. Date: Nov. 20, 2008

(54) Liquid crystal display driving system and method for driving the same

(76) Inventors: Yuhren Shen, Tainan City (TW); Chang-Cheng Lin, Taipei City (TW); Cheng-Chung Peng, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/798,788

(22) Filed: May 17, 2007

(51) Int. Cl. G06F 3/038

(52) U.S. Cl. 345/214

(57) ABSTRACT

The present invention discloses a liquid crystal display driving system that uses at least one temperature sensor to detect a temperature of a LCD panel, and outputs a gamma compensation voltage value according to the detected temperature, and further uses an overdrive compensation unit to receive the gamma compensation voltage value, and obtains the overdrive compensation voltage value of two gamma overdrive compensation curves of a temperature gradient corresponding to a region of the LCD panel by a gamma mapping method, or uses an overdrive compensation unit to derive a corresponding partial compensation data table according to the temperature and the compensation data table, and at least one overdrive compensation table (OD compensation table) corresponding to the change of temperature gradient in a region of the LCD panel is derived, an outputted display image after being processed by an overdrive lookup table (OD LUT) is compensated, so as to adjust the overdrive voltage of the LCD panel and enhance the response time of the liquid crystal display.

### FIELD OF THE INVENTION

The present invention relates to a liquid crystal display (LCD) driving system, and more particularly to a driving system that uses a temperature sensor to detect a temperature of a region of a LCD panel and adjusts an overdrive voltage according to a temperature gradient of the LCD panel, so as to improve the response time of a liquid crystal display.

### BACKGROUND OF THE INVENTION

As liquid crystal display becomes increasingly popular, and the scope of its application becomes more extensively in many areas from calculators, electronic clocks and radios at the early stage to notebook computers, desktop computers and televisions, and thus traditional cathode ray tube display devices are progressively replaced by liquid crystal display devices.

Due to the properties of the liquid crystal molecules of a liquid crystal display, liquid crystal molecules are twisted to change their alignment when image data is converted, and thus it is quite common to have a delayed screen. When the liquid crystal display was applied in a computer in the past, most of the displays were static images, and thus the delay was not significant. However, most liquid crystal displays applied in televisions, games, and movies involve dynamic images, and the delay results in blurred images and contrast distortions. In other words, the liquid crystal response time is too slow for the present applications. To solve the aforementioned problem, the overdrive technology is developed to enhance the liquid crystal response time, and its principle is to improve the driving voltage to speed up the liquid crystal response time. In other words, the voltage of a source drive supplied to a liquid crystal display is changed to trigger the twisting of liquid crystal molecules.

Referring to FIG. 1 for a timing diagram of a pixel voltage and its light transmission rate V1 of a conventional liquid crystal display, the pixel voltage is marked by a solid line, and the light transmission rate V1 is marked by a dotted line. When a pixel in the liquid crystal display 1 is switched from a data voltage C1 into a data voltage C2, there is a delay time during the electric charge due to the properties of the liquid crystal molecules, and thus the liquid crystal molecules cannot be deflected to a predetermined angle within a frame period to achieve a predetermined light transmission rate. In FIG. 1, frame N stands for the length of a frame period, and frames N+1, N+2, and so on represent successive coming frame periods after frame N. In the curve of the light transmission rate V1 as shown in FIG. 1, the light transmission rate V1 cannot reach the predetermined transmission rate within the frame period of frame N, and it is necessary to wait till the frame period of frame N+2 to achieve the predetermined transmission rate, but such delay will cause a ghosting phenomenon of the liquid crystal display.

Referring to FIG. 2 for a timing diagram of a pixel voltage and its light transmission rate V2 of a liquid crystal display adopting a conventional overdrive method, the response time of the liquid crystal molecules can be accelerated by adding an overdrive data voltage C3 when a pixel of the liquid crystal display is switched from a data voltage C1 to a data voltage C2. In FIG. 2, an overdrive data voltage C3 larger than the data voltage C2 is added when the data voltage C1 is switched to a larger data voltage C2. Since a higher data voltage can provide a faster liquid crystal response time, therefore the foregoing overdrive method can deflect liquid crystal molecules of a pixel to a predetermine angle within a frame period to achieve the predetermined light transmission rate. In FIG. 2, the light transmission rate V2 within a frame period of frame N can reach the predetermined transmission rate. However, this prior art applies equal overdrive data voltage to the entire LCD panel, and thus the effect on improving the delay of liquid crystal molecules is limited, because the liquid crystal molecules of a LCD panel are twisted by the change of voltages. Liquid crystal response time varies with temperature at each region of the LCD panel. For example, a higher temperature requires a higher response time. On the other hand, a slower response time requires a higher voltage. To solve the aforementioned problem, a method of installing a thermal sensor to the LCD panel for detecting temperature is provided. Referring to FIG. 3 for a schematic block diagram of a driving circuit of a conventional LCD panel, the driving circuit 1 comprises an image input terminal 111, a frame memory controller 113, a frame memory 114, an overdrive lookup table (OD LUT) 112, a ROM controller 117, a temperature controller 115, a read only memory (ROM) 116, a timing controller 118 and a thermal sensor 101. The thermal sensor 101 is installed on a LCD panel 10 for generating a temperature compensation signal St according to the temperature of the panel 10, and the image input terminal 111 inputs the current data and transmits the current data to the overdrive lookup table (OD LUT) 112 and the frame memory controller 113, so that the frame memory controller 113 continuously transmits and saves the current data into the frame memory 114. After the current data has been delayed for a frame period, the current data stored in the frame memory 114 is read and transmitted to the overdrive lookup table (OD LUT) 112, and the current data delayed for a frame period is defined as past data. Now, the temperature compensation signal St is transmitted to the temperature controller 115, so that the ROM controller 117 selects a parameter table from a plurality of parameter tables saved in a read only memory (ROM) 116 according to the temperature compensation signal St, and sends the parameter to the overdrive lookup table (OD LUT) 112 to adjust the operation of the overdrive lookup table (OD LUT) 112, and the timing controller 118 transmits the adjusted overdrive code to the LCD panel 10.

However, the LCD panel may be used in different conditions and room temperatures, and thus the overdrive voltage of the LCD panel has to wait till the display device is warmed up to an operating temperature or a stable temperature before it works, and the thermal sensor detects an ambient temperature or a temperature at a panel area of the LCD panel as the temperature for other areas of the panel, and the same overdrive voltage is used for the compensation, but most panels usually have a discrepancy of temperature. In general, the temperature at the up area of the panel is higher than the temperature at the bottom area of the panel. As the size of a LCD television tends to become increasingly bigger, the change of the temperature gradient becomes very significant, and thus causing the overdrive code of the LCD panel unable to compensate the aforementioned change of temperature gradient accurately. In other words, the conventional overdrive code only optimizes a specific area of the panel only, but it has inconsistent intensity at other areas and affects the resolution of the LCD.

In view of the foregoing shortcomings of the prior art, the inventor of the present invention based on years of experience in the image processing related field to conduct extensive researches and experiments, and finally invented a liquid crystal display driving system to overcome the foregoing shortcomings of the prior art.

### SUMMARY OF THE INVENTION

It is a primary objective of the present invention to provide a liquid crystal display driving system that takes a temperature gradient of a LCD panel into consideration for the compensation of an overdrive voltage.

To achieve the foregoing objective, the present invention provides a liquid crystal display driving system that comprises a LCD panel, a frame memory, at least one read only memory (ROM), an image input terminal, a ROM controller, a frame memory controller, an overdrive lookup table (OD LUT), an overdrive compensation unit and a timing controller.

The LCD panel includes a plurality of driving components and a temperature sensor, wherein the driving components are used for receiving a display signal to drive the LCD panel to display a screen; the temperature sensor is used for detecting a temperature of the LCD panel; the frame memory is used for saving image data values; the read only memory (ROM) is used for saving a plurality of voltage values of gamma compensation; the image input terminal is used for inputting an image data value; the ROM controller is used for outputting a corresponding voltage value of gamma compensation according to the temperature detected by the temperature sensor, looking up the outputting overdrive voltage value of the image, and transmitting the temperature; the frame memory controller is used for fetching a previous image data value; the overdrive lookup table (OD LUT) is used for selecting an image data value from the selected table according to the comparison of a current image data value and a previous image data value to produce a comparison result value, and a corresponding overdrive voltage value of the image is read from the ROM controller to compensate a new image data value according to the comparison result value, so as to output a display image data value. The overdrive compensation unit is used for receiving the display image data value, the voltage value of the gamma compensation, and the temperature. An overdrive compensation voltage value of up and bottom gamma overdrive compensation curves corresponding to a temperature gradient within the range of the LCD panel is obtained from the voltage value of the gamma compensation and the temperature through a gamma mapping method, and the display image data value is compensated according to the overdrive compensation voltage value. The timing controller is used for outputting a display signal corresponding to the compensated display image data value to the driving components of the LCD panel, and the driving components are electrically coupled to a plurality of scan lines and a plurality of data lines of the LCD panel for controlling the overdrive voltage required by each pixel, accelerating response time of the liquid crystal molecules, and enhancing the liquid crystal display response time.

Further, the driving system can use the compensation data table to obtain at least one overdrive compensation table of each area to compensate the display image data value, and the driving system can also use a plurality of temperature sensors to detect the temperature at different areas of the LCD panel and derive at least one overdrive compensation table of each area of the whole LCD panel corresponding to the compensation data table of each temperature sensor to compensate the overdrive voltage of the display image.

The feature of the present invention is to use an overdrive compensation voltage value of the gamma overdrive compensation or overdrive compensation table for the compensation according to different temperatures, and different areas of the LCD panel have different overdrive voltages, thereby corresponding to the change of temperature gradient precisely, accelerating the response time of liquid crystal molecules, and improving the quality of display screen.

To make it easier for our examiner to understand the objective of the invention, its structure, innovative features, and performance, we use preferred embodiments together with the attached drawings for the detailed description of the invention.

### BRIEF DESCRIPTION OF THE DRAWINGS

FIG. 1 is a timing diagram of a pixel voltage and its light transmission rate V1 of a conventional liquid crystal display;

FIG. 2 is a timing diagram of a pixel voltage and its light transmission rate V1 of a liquid crystal display adopting a conventional overdrive method;

FIG. 3 is a schematic block diagram of a driving circuit of a conventional LCD panel;

FIG. 4 is a schematic block diagram of a liquid crystal display driving system in accordance with the present invention;

FIG. 5 is a graph showing two gamma overdrive compensation curves obtained by a gamma mapping method in accordance with the present invention;

FIG. 6 is a schematic block diagram of another liquid crystal display driving system in accordance with the present invention;

FIG. 7 is a compensation data table of another liquid crystal display driving system in accordance with the present invention;

FIG. 8 is a schematic block diagram of a further liquid crystal display driving system in accordance with the present invention;

FIG. 9 shows up and bottom compensation data tables D and E of a further liquid crystal display driving system as depicted in FIG. 8 in accordance with the present invention; and

FIG. 10 is a schematic block diagram of another further liquid crystal display driving system in accordance with another preferred embodiment of the present invention.

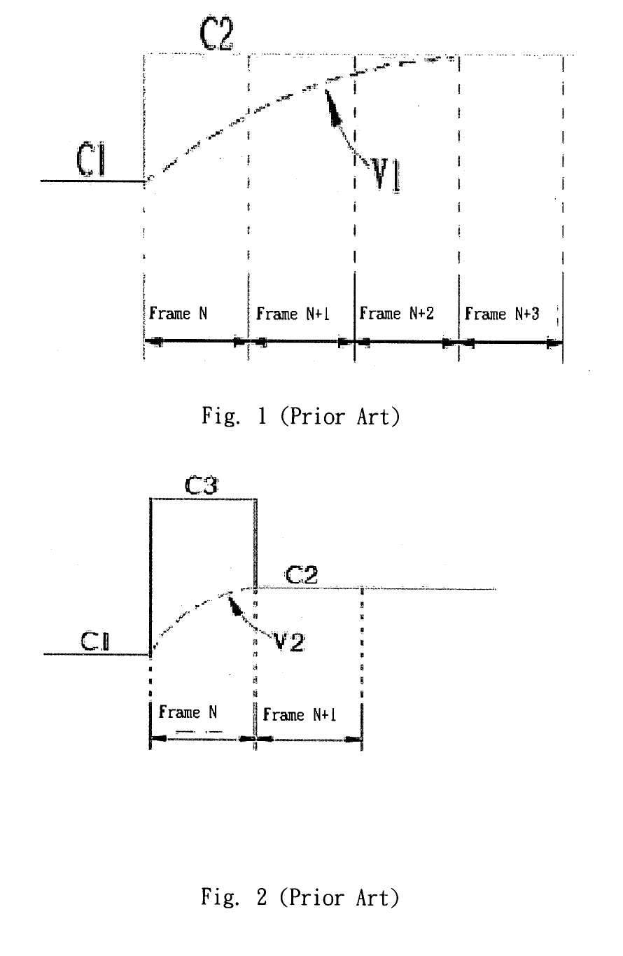

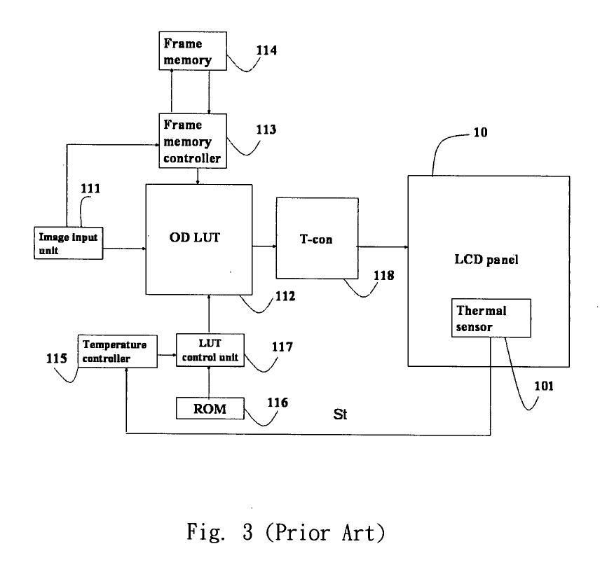

### DETAILED DESCRIPTION OF THE PREFERRED EMBODIMENTS

In the related figures of a preferred embodiment of the present invention, the same referring numerals are used for the same elements in accordance with the present invention.

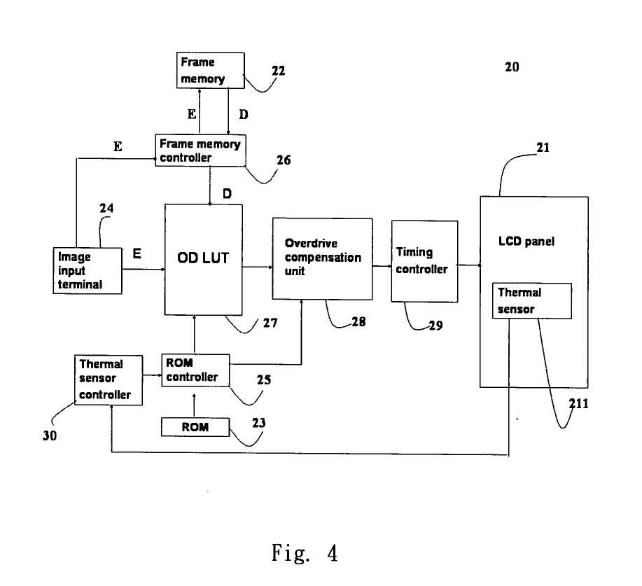

Referring to FIG. 4 for a schematic block diagram of a liquid crystal display driving system in accordance with the present invention, the system 20 comprises a LCD panel 21, a frame memory 22 and a read only memory (ROM) 23, an image input terminal 24, a ROM controller 25, a frame memory controller 26, an overdrive lookup table (OD LUT) 27, an overdrive compensation unit 28 and a timing controller 29.

The image input terminal 24 is used for inputting an image data value E and further transmitting the image data value E to the frame memory controller 26 and the overdrive lookup table (OD LUT) 27. After the frame memory controller 26 transmits the image data value E to one of the frame memories 22 for saving and fetches and transmits a previous image data value D saved in the frame memory 22 to the overdrive lookup table (OD LUT) 27, the overdrive lookup table (OD LUT) 27 selects an image data value from a selected table according to comparison of the outputted image data value E and the previous image data value D to produce a comparison result value, and the ROM controller 25 looks up and reads a corresponding gamma image overdrive voltage value according to the comparison result value and outputs an overdriven and compensated new image data value E for outputting a display image data value. A temperature sensor 211 installed at the middle of the LCD panel 21 is used for detecting the temperature of the panel, such that a thermal sensor controller 30 can receive a thermal sensing signal according to the temperature detected by the temperature sensor 211 and the voltage value of the gamma compensation curve corresponding to the temperature is outputted through the ROM controller 25 to the overdrive compensation unit 28 from the compensated voltage values of a plurality of the gamma compensation curves saved in the read only memory (ROM) 23. The overdrive compensation unit 28 receives an image data value, a voltage value of the gamma compensation curve and the temperature, and two overdrive compensation voltage values of up and bottom or left and right gamma overdrive compensation curves corresponding to a temperature gradient of the LCD panel are obtained from the voltage value of the gamma compensation and the temperature through a gamma mapping method, and the display image data value outputted by the overdrive lookup table (OD LUT) 27 is dynamically adjusted according to the overdrive compensation voltage value. The timing controller 29 then outputs a display signal which corresponds to the compensated display image data value to the driving components (not shown in the figure) of the LCD panel 21, and further drives the LCD panel 21 to display a screen.

The driving component is electrically coupled to a plurality of scan lines and a plurality of data lines of the LCD panel. The temperature sensor 211 is installed at the middle of the LCD panel 21 for generating a temperature signal, and the temperature signal is transmitted to a thermal sensor controller 30 and provided for the ROM controller 25 as a basis for outputting the voltage value corresponding to the gamma compensation curve. The frame memory 22 is generally a dynamic random access memory (DRAM), and the dynamic random access memory (DRAM) is preferably a synchronous dynamic random access memory (SDRAM) for saving image data values, and a read only memory (ROM) 23 is generally a read only memory (ROM), and the read only memory (ROM) is used for saving a plurality of outputted values corresponding to the gamma voltage. The gamma mapping method relates to a gamma correction for mapping the gray code in a grayscale range of the image data to a gray code of the corresponding grayscale range of the corresponding region to improve the maximum gamma voltage and reduce the minimum gamma voltage, so as to compensate the gamma voltage corresponding to the gray code. The display signal has a compensated gamma voltage, and each inputted image data is an 8-bit data consisted of three primary colors: red, green and blue (RGB) and transmitted to the frame memory controller 26 and the overdrive lookup table (OD LUT) 27. The image data value is used for controlling the pixel at the grayscale value of red, green and blue, and the grayscale of each color has 28 (which equals to 256) levels. To achieve a true color image formed by red, green and blue colors, the pixel needs an image data that requires 8×3 (which equals to 24) bits.

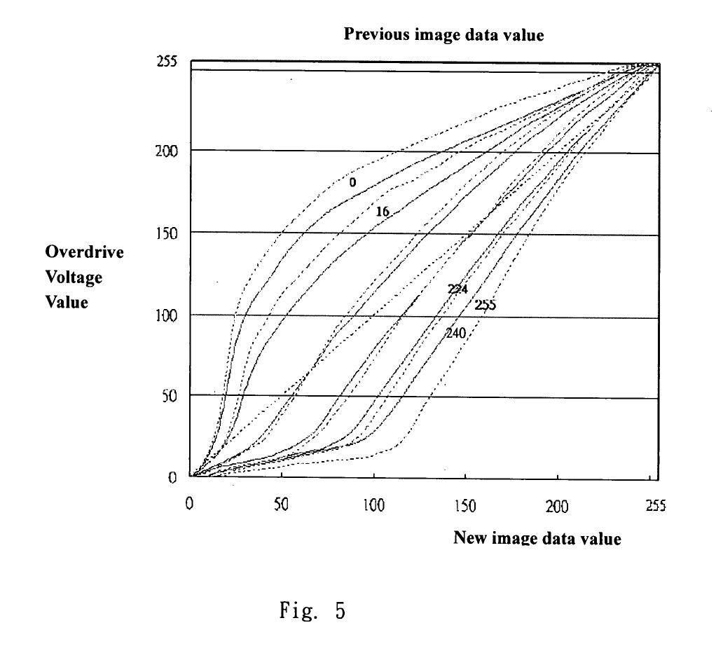

Referring to FIG. 5 for a graph showing two gamma overdrive compensation curves obtained by a gamma mapping method in accordance with the present invention, the y-axis is the overdrive code, and the x-axis is the digital value of previous and new image data value. If the gray code 240 of an image data value mapped into a gray code 255 is one of the compensated gamma voltages at the bottom area of the LCD panel, the gray code 224 will be another compensated gamma voltage at the upper area of the LCD panel.

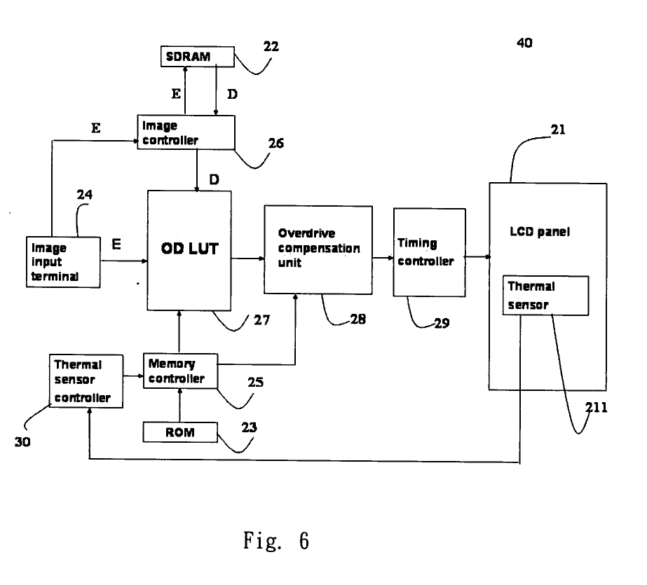

Referring to FIG. 6 for a schematic block diagram of another liquid crystal display driving system in accordance with the present invention, the system 40, similar to that as shown in FIG. 4 comprises a LCD panel 21, a synchronous dynamic random access memory (SDRAM) 22, a read only memory (ROM) 23, an image input terminal 24, a memory controller 25, an image controller 26, an overdrive lookup table (OD LUT) 27, an overdrive compensation unit 28 and a timing controller 29.

The method of processing image data by the image input terminal 24, the image controller 26, the synchronous dynamic random access memory (SDRAM) 22 and the overdrive lookup table (OD LUT) 27 is similar to that as illustrated in FIG. 4, and thus will not be described here again. The thermal sensor 211 installed at the middle of the LCD panel 21 detects the temperature of the panel, and when the temperature sensor controller 30 receives the thermal sensing signal generated by the detected temperature of the thermal sensor 211, an overdrive LUT corresponding to the temperature is outputted to the overdrive lookup table (OD LUT) 27 from a plurality of overdrive LUTs, and transmitted to an overdrive compensation unit 28. The overdrive compensation unit 28 is used for receiving the display image data value, the overdrive lookup table (OD LUT) of the compensated data and the temperature of the corresponding area provided by the memory controller 25 are used for calculating the corresponding two partial compensation data tables are calculated from the overdrive lookup table (OD LUT) of the compensated data and the temperature, and a corresponding temperature gradient of a region of the LCD panel 21 is used for deriving at least one overdrive compensation table, and the display image data value outputted by the overdrive lookup table (OD LUT) 27 is compensated according to the overdrive compensation table. The timing controller 29 outputs a display signal corresponding to the compensated display image data value to driving components (not shown in the figure) of the LCD panel 21 and further drives the LCD panel 21 to display a screen.

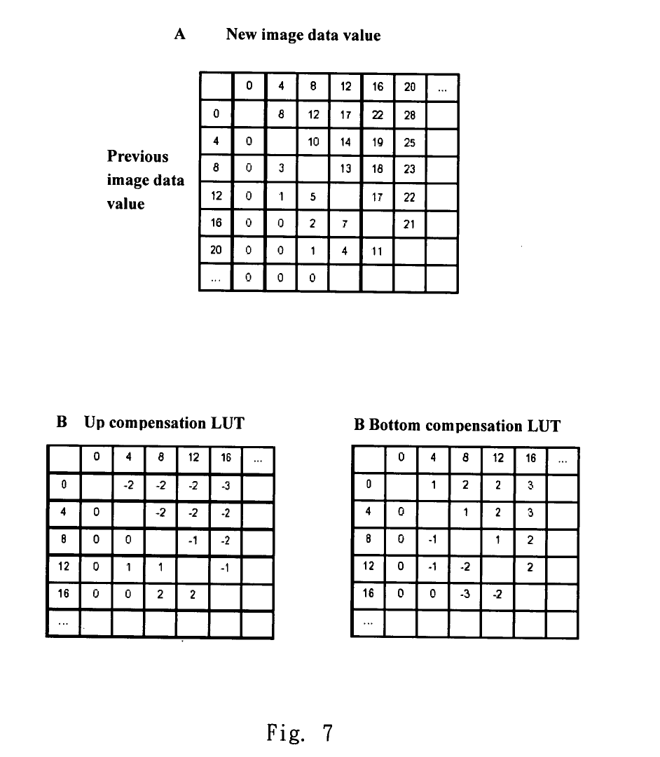

Referring to FIG. 7 for a compensation data table of another liquid crystal display driving system in accordance with the present invention, the overdrive LUT A is a primitive OD LUT, and its rows and columns use a partition 4 as a reference corresponding to a new image data value and a previous image data value respectively. If the temperature sensor detects a temperature of the LCD panel, two compensation LUTs B and C of the up area and bottom area of the LCD panel corresponding to the primitive OD LUT can be obtained, and a compensation method (such as an interpolation method) is used for deriving at least one overdrive compensation table that fits a temperature gradient of a region of the LCD panel. The interpolation method is a linear interpolation method, a bilinear interpolation method or any other interpolation method. Since the up region of the LCD panel has a higher temperature (or a faster response time) as shown in the compensation LUT B, and the bottom region has a lower temperature (or a slower response time) as shown in the compensation LUT C, it is necessary to slightly adjust the overdrive voltage, such as decreasing the value for the up region in the compensation LUT by 2, and increasing the value for the bottom region in the compensation LUT by 1. Similarly, the overdrive compensation table derived from the temperature gradient is used for adjusting the overdrive voltage of the entire LCD panel, so that the intensity of the display signal received by the driving components of the LCD panel is consistently the same.

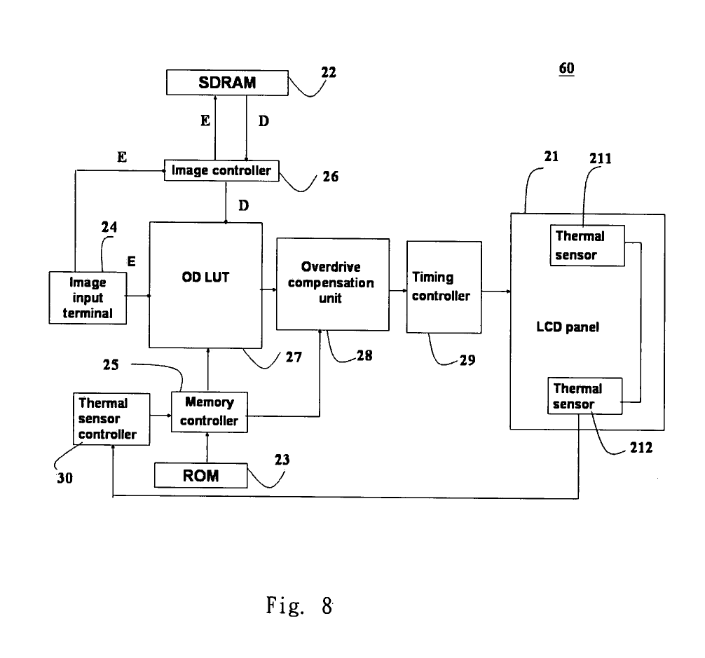

Referring to FIG. 8 for a schematic block diagram of a further liquid crystal display driving system in accordance with the present invention, the system 60, similar to the one as illustrated in FIG. 4 comprises a LCD panel 21, a synchronous dynamic random access memory (SDRAM) 22, a read only memory (ROM) 23, an image input terminal 24, a memory controller 25, an image controller 26, an overdrive lookup table (OD LUT) 27, an overdrive compensation unit 28 and a timing controller 29.

The method of processing the image data by the image input terminal 24, image controller 26, and the synchronous dynamic random access memory (SDRAM) 22 is substantially the same as that illustrated in FIG. 4 and thus will not be described here again. The difference resides in that the overdrive lookup table (OD LUT) 27 is not exactly the same as illustrated in FIG. 4, and the two overdrive lookup tables (OD LUT) are read according to the temperature at a region of the LCD panel as described below. The LCD panel 21 has two thermal sensors 211, 212 installed at the up and bottom areas of the LCD panel 21 respectively for detecting the temperature of the LCD panel 21. When the temperature sensor controller 30 receives the thermal sensing signal generated by the detected temperature of the thermal sensors 211, 212, and two overdrive lookup tables (OD LUT) corresponding to the thermal sensors 211, 212 are outputted to the overdrive lookup table (OD LUT) 27, and then transmitted to the overdrive compensation unit 28. The overdrive compensation unit 28 receives the display image data value, the overdrive lookup tables (OD LUT) corresponding to thermal sensors 211, 212 and the temperature provided by the memory controller 25, and at least one overdrive compensation table is derived from the overdrive lookup table (OD LUT) and the temperature corresponding to a temperature gradient of a region of the LCD panel 21, and the display image data value outputted by the overdrive lookup table (OD LUT) 27 is compensated according to the overdrive compensation table. The timing controller 29 outputs a display signal corresponding to the compensated display image data value to driving components (not shown in the figure) of the LCD panel 21 and further drives the LCD panel 21 to display a screen.

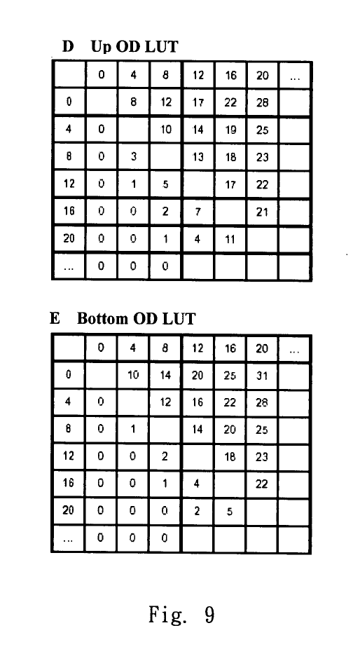

Referring to FIG. 9 for up and bottom compensation data tables D and E of a further liquid crystal display driving system as depicted in FIG. 8 in accordance with the present invention, the up and bottom compensation LUTs D and E are loaded according to the temperatures detected by thermal sensors at the up and bottom areas of the LCD panel, and then the display image data value processed and outputted by the overdrive lookup table (OD LUT) is calculated by the overdrive compensation unit based on the up and bottom compensation LUTs D, E corresponding to the temperature gradient of the up and bottom areas of the LCD panel using the interpolation method so as to further compensate the display image data value. If the voltage applied to a driving component tends toward the up area of the panel, the weight of the strength of the overdrive voltage of the up area will be increased. If the voltage applied to a driving component tends toward the bottom area of the panel, the weight of the strength of the overdrive voltage of the bottom area will be increased, and thus interpolations are performed for different areas individually.

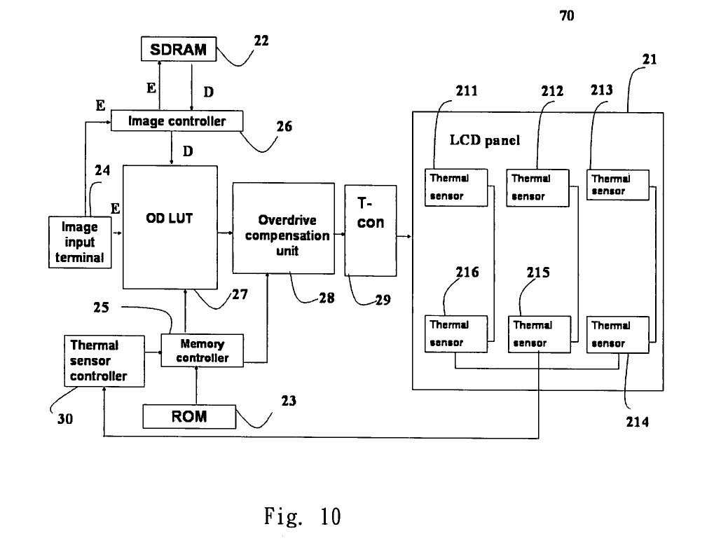

Further, a plurality of the thermal sensor 211, 212, 213, 214, 215, 216 can be installed in the LCD panel 21 with a driving system 70 as shown in FIG. 10, disposed at the up and bottom regions of the LCD panel 21. The memory controller 25 outputs the same number of compensation data tables corresponding to the number of the thermal sensors according to the detected temperature of the thermal sensors 211, 212, 213, 214, 215 and 216, and the following steps are the same as those illustrated in FIG. 6. The overdrive lookup table (OD LUT) 27 including a plurality of overdrive lookup tables (OD LUT) of the corresponding thermal sensors 211, 212, 213, 214, 215, 216 is received and transmitted to the overdrive compensation unit 28. The overdrive compensation unit 28 receives the display image data value, a plurality of overdrive lookup tables (OD LUT) corresponding to the thermal sensors 211, 212, 213, 214, 215, 216 and the temperature provided by the memory controller 2. At least one overdrive compensation table is derived from a plurality of overdrive lookup tables (OD LUT) and a temperature corresponding to a temperature gradient of a region of the LCD panel 21. The display image data value outputted by the overdrive lookup table (OD LUT) 27 is compensated according to the overdrive compensation table, and outputted by the timing controller 29 to a driving component of the LCD panel 21 to further drive the LCD panel 21 to display a screen.

While the invention has been described by way of example and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A liquid crystal display driving system, comprising:
a LCD panel having a plurality of driving components and a temperature sensor, and the driving component for receiving a display signal to drive the LCD panel to display a screen, and the temperature sensor for detecting a temperature of the LCD panel;
an image input terminal for inputting an image data value;
a frame memory for saving the image data value;
at least one read only memory (ROM) for saving a plurality of gamma compensation voltage values and a plurality of image overdrive voltage values;
a ROM controller for outputting the corresponding gamma compensation voltage value according to the temperature detected by the temperature sensor, and looking up and outputting the image overdrive voltage value, and transmitting the temperature;
a frame memory controller for fetching a previous image data value;
an overdrive lookup table (OD LUT) for selecting an image data value from a selected table according to comparison of a current image data value and the previous image data value to produce a comparison result value, and looking up and reading the corresponding the image overdrive voltage value through the ROM controller according to the comparison result value to compensate a new image data value, thereby outputting a display image data value;
an overdrive compensation unit for receiving the display image data value, the gamma compensation voltage value and the temperature, obtaining an overdrive compensation voltage value of two gamma overdrive compensation curves corresponding to a temperature gradient within the range of the LCD panel from the gamma compensation voltage value and the temperature by using a gamma mapping method, and compensating the display image data value according to the overdrive compensation voltage value; and
a timing controller for outputting the display signal corresponding to the compensated display image data value to the driving component of the LCD panel.

2. The liquid crystal display driving system as recited in claim 1, wherein the driving component is electrically coupled to a plurality of scan lines and a plurality of data lines of the LCD panel.

3. The liquid crystal display driving system as recited in claim 1, wherein the temperature sensor is a thermal sensor installed at the middle portion of the LCD panel to generate a temperature signal.

4. The liquid crystal display driving system as recited in claim 1, wherein the read only memory (ROM) is a read only memory (ROM).

5. The liquid crystal display driving system as recited in claim 1, wherein the frame memory is a dynamic random access memory (DRAM).

6. The liquid crystal display driving system as recited in claim 5, wherein the dynamic random access memory (DRAM) is a synchronous dynamic random access memory (SDRAM) for saving the image data value.

7. The liquid crystal display driving system as recited in claim 1, wherein the gamma mapping method is a gamma correction used for adjusting the voltage values of a gamma curve.

8. A liquid crystal display driving system, comprising: a LCD panel having a plurality of driving components and a temperature sensor, and the driving component for receiving a display signal to drive the LCD panel to display a screen, and the temperature sensor for detecting a temperature of the LCD panel;
an image input terminal for inputting an image data value;
a frame memory for saving the image data value;
at least one read only memory (ROM) for saving plurality of records of compensation data tables and a plurality of image overdrive voltage values;
a ROM controller for outputting the corresponding compensation data table according to the temperature detected by the temperature sensor, looking up and outputting the image overdrive voltage value, and transmitting the temperature;
a frame memory controller for fetching a previous image data value; an overdrive lookup table (OD LUT) for selecting an image data value from selected table according to comparison of a current image data and the previous image data value to produce a comparison result value, and looking up and reading the corresponding the image overdrive voltage value through the ROM controller according to the comparison result value to compensate a new image data value to output a display image data value, and transmitting the compensation data table outputted from the ROM controller;
an overdrive compensation unit for receiving the display image data value, the compensation data table and the temperature, deriving two corresponding partial compensation data tables from the compensation data table and the temperature, and deriving at least one overdrive compensation table corresponding to a temperature gradient within the range of the LCD panel, and compensating the display image data value according to the overdrive compensation table; and
a timing controller for outputting the display signal corresponding to the compensated display image data value to the driving component of the LCD panel.

9. The liquid crystal display driving system as recited in claim 8, wherein the driving component is electrically coupled to a plurality of scan lines and a plurality of data lines of the LCD panel.

10. The liquid crystal display driving system as recited in claim 8, wherein the temperature sensor is a thermal sensor installed at the middle of the LCD panel for generating a temperature signal.

11. The liquid crystal display driving system as recited in claim 8, wherein the read only memory (ROM) is a read only memory (ROM).

12. The liquid crystal display driving system as recited in claim 8, wherein the frame memory is a dynamic random access memory (DRAM).

13. The liquid crystal display driving system as recited in claim 12, wherein the dynamic random access memory (DRAM) is a synchronous dynamic random access memory (SDRAM) for saving the image data value.

14. The liquid crystal display driving system as recited in claim 8, wherein the overdrive compensation table is calculated by a compensation method, and the compensation method is an interpolation method.

15. The liquid crystal display driving system as recited in claim 14, wherein the interpolation method is a linear interpolation method, a bilinear interpolation method or another interpolation algorithm.

16. A liquid crystal display driving system, comprising:
a LCD panel having a plurality of driving components and a plurality of temperature sensors, and the driving component for receiving a display signal to drive the LCD panel to display a screen, and the temperature sensor for detecting a plurality of temperatures of the LCD panel;
an image input terminal for inputting an image data value;
a frame memory for saving the image data value;
at least one read only memory (ROM) for saving plurality of records of compensation data tables and plurality of image overdrive voltage values;
a ROM controller for outputting the corresponding plurality of compensation data tables according to the temperature detected by the temperature sensor, looking up and outputting the image overdrive voltage value, and transmitting the temperature;
a frame memory controller for fetching a previous image data value;
an overdrive lookup table (OD LUT) for selecting an image data value from selected table according to comparison of a current image data value and the previous image data value to produce a comparison result value, looking up and reading the corresponding the image overdrive voltage value through the ROM controller according to the comparison result value to output a display image data value, and transmitting the plurality of compensation data tables corresponding to the temperature sensors from the ROM controller;
an overdrive compensation unit for receiving the display image data value, the compensation data tables corresponding to the temperature sensors and the temperature, and deriving at least one overdrive compensation table corresponding to a temperature gradient within the range of the LCD panel from the compensation data table and the temperature, and compensating the display image data value according to the overdrive compensation table; and
a timing controller for outputting the display signal corresponding to the compensated display image data value to the driving component of the LCD panel.

17. The liquid crystal display driving system as recited in claim 16, wherein the driving component is electrically coupled to a plurality of scan lines and a plurality of data lines of the LCD panel.

18. The liquid crystal display driving system as recited in claim 16, wherein the temperature sensor is a thermal sensor installed at each region of the LCD panel for generating a plurality of temperature signals.

19. The liquid crystal display driving system as recited in claim 16, wherein the read only memory (ROM) is a read only memory (ROM).

20. The liquid crystal display driving system as recited in claim 16, wherein the frame memory is a dynamic random access memory (DRAM).

21. The liquid crystal display driving system as recited in claim 20, wherein the dynamic random access memory (DRAM) is a synchronous dynamic random access memory (SDRAM) for saving the image data value.

22. The liquid crystal display driving system as recited in claim 16, wherein the overdrive compensation table is calculated by a compensation method, and the compensation method is an interpolation method.

23. The liquid crystal display driving system as recited in claim 22, wherein the interpolation method is a linear interpolation method, a bilinear interpolation method or another interpolation algorithm.

24. The liquid crystal display driving system as recited in claim 22, wherein the interpolation method is derived from a plurality of compensation data tables corresponding to the temperature sensor.
